(19) United States
(12) Patent Application Publication
(10) Pub. No.: US 2007/0193530 A1
(43) Pub. Date: Aug. 23, 2007

(54) Pet hair removal device

(76) Inventor: James Joseph Deroo, Farmington Hills, MI (US)

Correspondence Address: Galasso & Associates, LP, P.O. Box 26503, Austin, TX, 78775-0503, US

(21) Appl. No.: 11/517,933

(22) Filed: Sep. 8, 2006

Related U.S. Application Data
(60) Provisional application No. 60/774,302, filed on Feb. 17, 2006.

(51) Int. Cl. A01K 13/00

(52) U.S. Cl. 119/618

(57) ABSTRACT

A device for the removal of pet and human hairs from hard to reach places such as crevices, narrow openings and folds in upholstery, as well as from confined clothing areas such as pockets is disclosed. The pet hair removal device comprises a flexible elongated handle body having a hand grip end portion together with an opposing pet hair collector end portion on the handle. The handle has an elongated flexible shaft and a pet hair collection member secured to the collector portion of the handle. The collection member is adapted to engage and retain pet hair on the pet hair removal device for removal from the item or surface being cleaned. The pet hair removal device can be manually cleaned of pet hair and reused. The pet hair removal device that is adapted to remove pet hair from hard to reach places such as between furniture cushions and between the seat back and base of a vehicle seat while being thin and flexible to permit navigation through thin crevices, around obstacles and reach into tight areas to extract pet hairs from fabrics, upholstery, clothing and the like. The device is low in cost and therefore of improved benefit and utility to the consumer.

### CROSS REFERENCE TO RELATED APPLICATIONS

This application claims priority to co-pending U.S. Provisional Patent Application having Ser. No. 60/774,302 filed Feb. 17, 2006 entitled “Aardvark”, having a common applicant herewith.

### FIELD OF THE DISCLOSURE

The disclosures made herein relate generally to a cleaning device for removing hairs and, more particularly, to cleaning devices to be rubbed over a surface to engage and collect and remove hairs, particularly pet hairs, from the surface.

### BACKGROUND

Pet hairs and human hairs are known to clingably adhere to upholstered chairs, rugs, clothing, etc. and are not easily brushed away or removed by vacuuming. Various types of lint removal devices are known in the art. One known type utilizes a lint roller on a handle, the roller having a tacky adhesive surface that adhesively engages the lint and hair, thereby binding the hair to the lint roller surface. Some known varieties of the lint roller have removable tape-like member on the roller such that a clean section of fresh tacky adhesive coated tape can be exposed to gather additional hair and lint.

This type of lint brush, however, has one or more drawbacks in that the lint roller itself is too bulky and large to be used to clean hard to reach places such as down in the cracks between the back and base of the seat in a vehicle or in between the cushions on couches and love seats, for example.

U.S. Pat. No. 5,230,303 to Rubino discloses another type of pet hair removal brush having a form similar to a conventional paint roller wherein the roller is provided with adhesive to engage and collect the hair. This type of lint brush suffers from drawbacks similar to the earlier example wherein the lint roller itself is too bulky and large to be used to clean hard to reach places in furniture and vehicles, for example.

U.S. Pat. No. 5,418,571 to Brazis et al. discloses another type of lint brush assembly having a handle with a substantially flat brush-like portion at one end where the lint removal media is attached. While this type of lint brush has a thinner profile, it is still cumbersome in size and further suffers from the lack of lint gathering and engaging media on the circumferential edges of the lint collection portion of the brush, making the brush ineffective in removing pet hair from hard to reach places such as cracks between seat cushion and folds in upholstery, etc. A further drawback is that the brush is non flexible and therefore does not conform to the contour and bend around obstructions to reach and remove pet hair.

Therefore, a pet hair removal device that is thin and flexible, a device that is adapted to remove pet hair from hard to reach places such as between furniture cushions and between the seat back and base of a vehicle seat, a pet hair removal device that has dimensions such that it easily fits into and reaches down into pockets and folds in fabric and furniture, a pet hair removal device that is low in cost and therefore of improved benefit to the consumer, such a pet hair removal device would be useful and novel.

### SUMMARY OF THE DISCLOSURE

Accordingly, embodiments of the inventive disclosures made herein comprise various embodiments of a pet hair removal device for removal of pet and human hairs from hard to reach places such as crevices, narrow openings and folds in upholstery, as well as from confined clothing areas such as pockets.

In a first embodiment of the inventive disclosures made herein, a pet hair removal device comprises a flexible elongated handle body having a hand grip end portion together with an opposing collector end portion on the handle. The handle has an elongated flexible shaft and a pet hair collection member secured to the collector portion of the handle, wherein the collection member is adapted to engage and retain pet hair on the device for removal from the item or surface being cleaned.

In a second embodiment, the elongated flexible shaft of the first embodiment is provided with a substantially thin rectangular cross section taken perpendicular to an axis of elongation. The thin, flexible shaft body configured to allow the brush to reach into crevices and tight areas for the removal of pet hair.

In a third embodiment, the elongated flexible shaft of the first embodiment has a substantially thin elliptical cross section when the section is taken perpendicular to an axis of elongation such that the surfaces of the shaft are rounded.

In a fifth embodiment a pet hair removal device comprises an elongated thin flexible handle body having a hand grip end portion and an opposing collector end portion. The handle comprises a central axis of elongation along the center of the handle, two elongated opposing major faces aligned with the axis and spaced apart about the axis and two elongated opposing minor faces aligned with the axis and spaced apart about the axis. The minor faces separated by a distance greater than distance separating the major faces and the minor faces are attached along opposing axially aligned edges with the axially aligned edges of the major faces such that major and minor faces form thin elongated body about the axis. A pet hair collection member is applied over the major and minor faces of the collector portion of the handle. The collection member is adapted to engage and retain pet hair on the device. The collector portion encloses all faces of the collection portion, including particularly the thin edges as well as the major faces of the collection portion.

In certain embodiments the collection member has a tacky adhesive coating for collecting and retaining pet hairs to the device. In subsets of these embodiments the tacky adhesively coated collecting member is removable from the handle and replaceable when a fresh collection member is required. In other subsets of these embodiments the collection member is permanently secured to the handle.

In certain embodiments the collection member comprises a fabric having hook members or hook and loop members configured for collecting and retaining pet hairs to the device. The collection member may be permanently secured to the brush handle.

In certain embodiments the collection member comprises a fabric secured to the handle, the fabric having substantially aligned cut filaments, the filaments directionally aligned to engage and retain pet hairs when brushed over a surface.

In one or more embodiments of the inventive disclosures made herein, the pet hair removal device has an overall length along the elongation axis of approximately 18 inches with the collection portion of the handle measuring approximately 12 inches in length and the handle grip portion measuring approximately 6 inches in length. The width of the collection member or brush measures 2 inches wide. The handle has a thickness of half and inch or less, the thickness chosen to permit the brush to remain flexible and to enter and navigates tight folds and hard to reach places.

It is an objective of the inventive disclosure made herein to provide a pet hair removal device that is adapted to remove pet hair from hard to reach places such as between furniture cushions and between the seat back and base of a vehicle seat.

It is another objective of the inventive disclosure made herein to provide a pet hair removal device that is thin and flexible to permit navigation through thin crevices and around obstacles.

It is another objective of the inventive disclosure made herein to provide a pet hair removal device that has dimensions such that it easily fits into and reaches down into pockets and folds and tight areas.

It is another objective of the inventive disclosure made herein to provide a pet hair removal device that is low in cost and therefore of improved benefit to the consumer.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of one embodiment of the pet hair removal device in accordance with the inventive disclosures herein.

FIG. 2 depicts a section view along ‘A-A’ of the pet hair removal device in accordance with the inventive disclosures herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

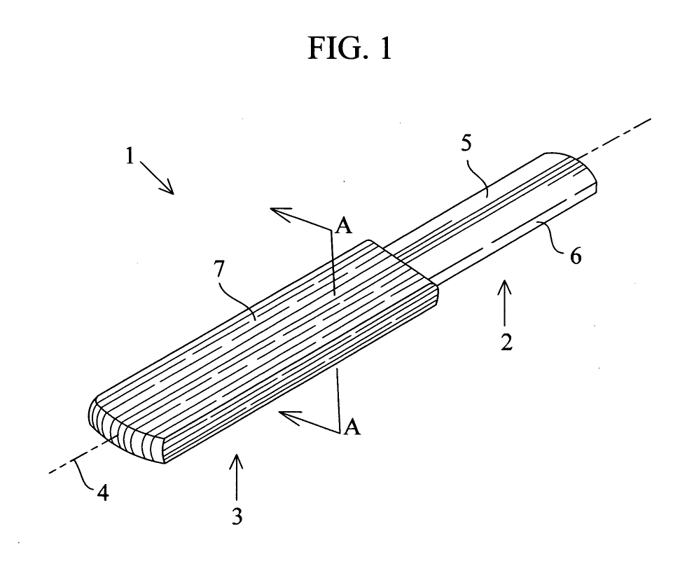

FIG. 1 depicts a perspective view of one embodiment of the pet hair removal device in accordance with the inventive disclosures herein. The pet hair removal device 1 comprises an elongated thin flexible handle body having a hand grip end portion 2 and an opposing pet hair collector end portion 3. The handle has a central axis of elongation 4, two elongated opposing major faces 5 aligned with the axis and spaced apart about the axis (only one is visible) and two elongated opposing minor faces 6 aligned with the axis and spaced apart about the axis (only one is visible). The minor faces are separated by a distance greater than distance separating the major faces. The minor faces are attached along opposing axially aligned edges with the axially aligned edges of the major faces such that major and minor faces form a wide and thin elongated body about the axis. A pet hair collection member 7 is positioned over the major 5 and minor 6 faces of the collector portion 3 of the handle. The collection member 7 is adapted to engage and retain pet hair on the pet hair removal device. As illustrated, the collector portion encloses all faces of the collection portion of the pet hair removal device so that all faces of the collection portion are available to engage and extract pet hair from an article or surface being cleaned of pet hair. In the illustrated embodiment the pet hair collection member 7 is a hook and loop fabric secured to the thin flexible handle.

In a preferred embodiment the pet hair removal device is a thin, flexible plastic brush with a hook and loop pet hair collection member. In the preferred embodiment the pet hair removal device has an overall length along the elongation axis of 18 inches. The collection portion of the handle has a length of 12 inches. The width of the collection member is 2 inches and the handle has a thickness of about 0.5 inches.

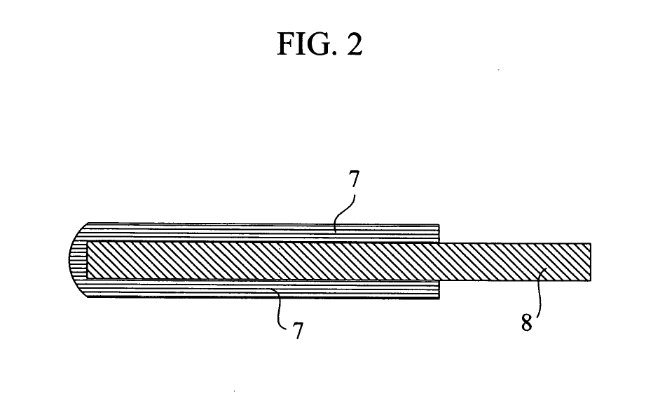

FIG. 2 depicts a sectional view along ‘A-A’ cut through the body of the pet hair removal device. The thin flexible handle body 8 has hook and loop fabric 7 adhered to opposing major faces of the handle body 8. The hook and loop fabric is the pet hair collection member of the illustrated embodiment.

The discussed construction, illustrations and sequence of operation is for one embodiment of the invention but is in no way limiting to other embodiments. The operating modes may be changed and enhanced without deviating from the intention of this inventive disclosure.

In the preceding detailed description, reference has been made to the accompanying drawings that form a part hereof and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A pet hair removal device, comprising:
an elongated flexible shaft-like handle body having a hand grip end portion and an opposing collector end portion; and
a pet hair collection member secured to the collector portion of the handle, wherein the collection member is adapted to engage and retain pet hair on the device.

2. The pet hair removal device of claim 1, wherein the elongated shaft has a substantially thin rectangular cross section when taken perpendicular to an axis of elongation.

3. The pet hair removal device of claim 1, wherein the elongated shaft has a substantially thin elliptical cross section when taken perpendicular to an axis of elongation.

4. The pet hair removal device of claim 1, wherein the rectangular cross section comprises one or more rounded edges wherein one or more surfaces of the shaft are rounded.

5. A pet hair removal device, comprising:
an elongated thin flexible handle body having a hand grip end portion and an opposing collector end portion, the handle comprising:
a central axis of elongation;
two elongated opposing major faces aligned with the axis and spaced apart about the axis; and
two elongated opposing minor faces aligned with the axis and spaced apart about the axis, the minor faces separated by a distance greater than distance separating the major faces, the minor faces attached along opposing axially aligned edges with the axially aligned edges of the major faces such that major and minor faces form thin elongated body about the axis;
a pet hair collection member applied over the major and minor faces of the collector portion of the handle, wherein the collection member is adapted to engage and retain pet hair on the device, and wherein the collector portion encloses all faces of the collection portion; and
a means of attaching the collection member to the collector portion of the handle.

6. The pet hair removal device of claim 5, wherein the collection member has a tacky adhesive coating for collecting and retaining pet hairs to the device.

7. The pet hair removal device of claim 5, wherein the collection member comprises tape having an adhesive side engaging the collection portion faces and opposing collection side comprising fabric hook and loop members for collecting and retaining pet hairs to the device.

8. The pet hair removal device of claim 5, wherein the collection member comprise a fabric secured to the handle, the fabric having substantially aligned cut filaments, the filaments directionally aligned to engage and retain pet hairs when brushed over a surface.

9. The pet hair removal device of claim 7 wherein the means of attaching the collection member comprises an adhesive coating on a back side of the member, wherein the collection member is removable and replaceable on the handle.

10. The pet hair removal device of claim 7 wherein the means of attaching the collection member comprises a permanently secured attachment means wherein the collection member is not replaceable on the handle.

11. The pet hair removal device of claim 7 wherein the pet hair removal device has an overall length along the elongation axis of 18 inches; wherein the collection portion of the handle is 12 inches in length; wherein the collection member is 2 inches wide; and wherein the handle body has a thickness not exceeding half an inch.
